(19) United States
(12) Patent Application Publication
(10) Pub. No.: US 2022/0348502 A1
(43) Pub. Date: Nov. 3, 2022

(54) AQUEOUS DISPERSION AND POLYMER MODIFIED CEMENT-BASED COATING COMPOSITION THEREOF

(71) Applicant: Wacker Chemie AG, Munich (DE)

(72) Inventors: Yun (Helen) Li, Shanghai (CN); Lei (Steve) Yang, Shanghai (CN); Yizheng (Josef) Gong, Shanghai (CN); Honggang (Henry) Chen, Shanghai (CN); Hu (Vincent) Yuan, Shanghai (CN)

(73) Assignee: Wacker Chemie AG, Munich (DE)

(21) Appl. No.: 17/620,723

(22) PCT Filed: Jun. 28, 2019
(86) PCT No.: PCT/CN2019/093526

§ 371 Date: Dec. 19, 2021

(51) Int. Cl. C04B 24/26; C04B 28/02; C04B 40/00

(52) U.S. Cl. CPC C04B 24/2635; C04B 28/02; C04B 24/2676; C04B 24/2623; C04B 40/0039; C04B 2103/30

(57) ABSTRACT

An aqueous dispersion and uses therefor. The aqueous dispersion includes a Component (a), Component (b) and Component (c). Where Component (a) is a polymer prepared by the polymerization of monomers comprising a vinyl ester and an ethylene, where Component (b) is an acrylate-based polymer and where Component (c) is water. A film that is formed from the aqueous dispersion has a glass transition temperature of less than or equal to −7° C. The aqueous dispersion the polymer of the Component (a) has a pot life of longer than or equal to 4 hours after being mixed with cement. Where Component (a) is present in an amount of higher than 35%, based on the total weight of the aqueous dispersion and Component (b) is present in an amount of less than or equal to 20%, based on the total weight of the aqueous dispersion.

### FIELD OF THE INVENTION

The present disclosure relates to an aqueous dispersion and a polymer modified cement-based coating composition thereof.

### BACKGROUND OF THE INVENTION

As a waterproof coating with excellent properties of inorganic cement and organic polymer materials, polymer modified cement-based coatings have received extensive attention and been widely investigated both at home and abroad thanks to their high strength and good adhesion to wet substrates featured by cement-based cementitious materials, as well as high flexibility, excellent resistance to cracking and good water resistance of polymer coating films.

At present, polymer dispersions used in polymer modified cement-based coatings are mainly acrylate dispersions and vinyl acetate-ethylene (VAE) copolymer dispersions. As VAE dispersions are usually featured by poor elasticity and water resistance as well as moderate alkali resistance, although the cement-based coatings modified with VAE dispersions have elongation at break up to the industry standards, their low-temperature flexibility cannot meet the requirements of industry standards unless a large amount of plasticizers is added. Acrylate dispersions are the best choices for preparing polymer modified cement-based coatings due to their good water and alkali resistance and low-temperature performance. However, in addition to high costs, ammoniacal odor may be released during the applications, as ammonia is often used as a pH regulator in the production process, which can cause irritations to painters.

Therefore, it is still necessary to develop a low-cost, safe and environmentally friendly polymer dispersion, so that polymer modified cement-based coatings prepared therefrom can achieve excellent low-temperature flexibility without adding a plasticizer while ensuring the tensile strength and elongation at break.

### SUMMARY OF THE INVENTION

In view of the existing problems, the aqueous dispersions provided by the present disclosure achieve the above objective by controlling the glass transition temperature of the film formed from the blend of VAE dispersions and acrylate dispersions and the pot life of the blending dispersion after being mixed with cement.

In the present disclosure, the glass transition temperature (Tg) is determined by a differential scanning calorimeter (DSC) in the temperature range of from −70° C. to 100° C. at a scan rate of 10° C./min, unless otherwise specified. Typically, Tg values include onset value, midpoint value, and offset value, wherein the onset value corresponds to the temperature value at the start of the glass transition on the heat flow-temperature curve, the offset value corresponds to the temperature value at the end of the glass transition, and the midpoint value corresponds to the temperature value of the intersection of the equidistant intermediate line, between the two parallel baselines before and after glass transition, and the heat flow-temperature curve. The Tg values used in the present disclosure are midpoint values, unless otherwise specified.

In the present disclosure, there are no special requirements for the process of “film formed from the aqueous dispersion” as long as the water in the aqueous dispersion can be evaporated to form a continuous film. As the “film formed from the aqueous dispersion” contains two or more polymers, it may have only one Tg value or at least two different Tg values, preferably only one Tg value. The wording “only one Tg value” means that only a single transition temperature is found on the heat flow-temperature curve, indicating that the blend of polymers is miscible and has a single phase characteristics of glass transition temperature. The wording “at least two different Tg values” means that two or more transition temperatures are found on the heat flow-temperature curve, indicating that the blend of polymers is immiscible and has multiphase characteristics of glass transition temperature.

In the present disclosure, the term “pot life” means the workability time for which the aqueous polymer dispersion and the cement remain usable after mixed at a mass ratio of 1:(0.8-1.2). The wording “remain usable” means such a state that the mixture of the aqueous polymer dispersion and the cement is not agglomerated and can still be stirred to form a slurry with good flow properties. In the present disclosure, pot lives are determined at 23±2° C. and 50±10% relative humidity, unless otherwise specified.

In the present disclosure, the term “content of ethylene units” means that the amount of ethylene copolymerized into Polymer (a), excluding the amount of vinyl groups in vinyl ester copolymerized into Polymer (a). The amount of ethylene copolymerized into a polymer is usually numerically lower than the charge of ethylene monomer because the conversion rate of ethylene monomer is generally less than 100% during the polymerization.

In the present disclosure, the “content of ethylene units” can be determined by a method known in the art, for example, by referring to the method specified in Appendix B of the chemical industry standard HG/T 2405-2005 of the People's Republic of China, or by nuclear magnetic resonance (NMR) spectroscopy. The test results are generally expressed as a percentage by mass of ethylene.

As used herein, the term “polymer modified cement-based coating” refers to polymer modified cement-based waterproofing coatings as defined in the Chinese national standard GB/T 23445-2009, specifically to two-component water-based waterproofing coatings prepared with polymer dispersions and cement as the main ingredients and additional fillers and other additives, which cure into a film through water evaporation and cement hydration reaction. Here, “two-component” means that the polymer modified cement-based coatings typically consist of a liquid component, usually comprising polymer dispersions and additives, and a powder component, usually comprising cement and fillers. The wording “polymer dispersions as the main ingredients” means that the proportion of polymer dispersions in the liquid component is at least 30 wt % or more, for example more than 40 wt %, more than 50 wt %, more than 60 wt %, more than 70 wt %, or even more than 80 wt %.

In the present disclosure, the term “plasticizer” refers to a non-aqueous liquid that can increase the plasticity of a polymer. Mechanism of plasticizer: As plasticizer molecules are inserted between molecular chains of a polymer, the force of attraction between the molecular chains is weakened, i.e. the aggregation of molecular chains is reduced and the mobility and flexibility of molecular chains are improved, thereby increasing the plasticity. In this way, the Tg of polymers can be effectively reduced.

The first aspect of the present disclosure provides an aqueous dispersion comprising:

(a) polymer prepared by the polymerization of monomers comprising a vinyl ester and ethylene,

(b) acrylate-based polymer, and

(c) water;

wherein film formed from the aqueous dispersion has a glass transition temperature of less than or equal to −7° C.; and

the aqueous dispersion has a pot life of longer than or equal to 4 hours after being mixed with cement.

### Component (a)

The vinyl esters typically include vinyl esters of linear or branched alkyl carboxylic acids having 1 to 15 carbon atoms, such as vinyl acetate, vinyl propionate, vinyl butyrate, vinyl pivalate, vinyl 2-ethylhexanoate, vinyl laurate, or any combination thereof.

In order to extend the properties of Polymer (a), in addition to the vinyl ester and ethylene monomers, there can be also included other comonomers, for example, halogenated ethylenes, such as vinyl chloride; olefins such as propylene; ethylenically unsaturated carboxylic acids and derivatives thereof, such as fumaric acid, maleic acid, maleic anhydride, acrylamide, and acrylonitrile; precrosslinking comonomers or postcrosslinking comonomers, such as divinyl adipate, diallyl maleate, allyl methacrylate, triallyl cyanurate, acrylamidoglycolic acid, methacrylamide glycolate methyl ester, N-methylol acrylamide, N-methylol methacrylamide, N-methylolallyl carbamate, isobutoxy ethers or esters of N-methylol acrylamide, isobutoxy ethers or esters of N-methylol methacrylamide, isobutoxy ethers or esters of N-methylolallyl carbamate; epoxy-functional comonomers such as glycidyl methacrylate and glycidyl acrylate; and silicon-functional comonomers such as vinyl trialkoxysilanes, vinyl methyl dialkoxysilanes.

In a preferred embodiment herein, Polymer (a) is a vinyl ester-ethylene copolymer, more specifically a vinyl acetate-ethylene copolymer.

In the present disclosure, the content of ethylene units derived from ethylene in Polymer (a) is preferably more than 22 wt %, for example, more than 22.5 wt %, 23 wt % or 23.5 wt % based on the total weight of Polymer (a).

The Tg of Polymer (a) is suitably less than or equal to 5° C., preferably less than or equal to 0° C., and more preferably less than or equal to −6° C.

In the present disclosure, the amount of Component (a) can be determined according to the Tg of Polymer (a) and the Tg of the film formed from the aqueous dispersion, preferably higher than 30%, more preferably higher than 35%, based on the total weight of the aqueous dispersion.

In the present disclosure, the polymer as Component (a) can be prepared by a conventional method in the art, typically by emulsion polymerization, and thus obtained in a form of polymer dispersion. The Polymer (a)-based dispersion has a pot life of preferably longer than or equal to 4 hours after being mixed with cement. In one embodiment herein, Polymer (a) is stably dispersed in water with polyvinyl alcohol.

### Component (b)

The acrylate-based polymer is obtained by polymerizing an acrylate monomer or a methacrylate monomer and optionally other functional monomers.

Typical acrylate-based polymers include any homopolymer or copolymer derived from the structural units of the following compounds: one or more esters of acrylic acid, such as methyl acrylate, ethyl acrylate, propyl acrylate, butyl acrylate, neopentyl acrylate, 2-ethylhexyl acrylate, decyl acrylate and phenyl acrylate; one or more esters of methacrylic acid, such as methyl methacrylate, ethyl methacrylate, propyl methacrylate, butyl methacrylate, neopentyl methacrylate, 2-ethylhexyl methacrylate, decyl methacrylate and phenyl methacrylate; and optionally other functional monomers, for example ethylenically unsaturated comonomers such as styrene, methyl styrene, ethyl styrene, chlorostyrene, bromostyrene, propylene amide, methacrylamide, methylol acrylamide, methylol methacrylamide, N-isobutoxymethyl acrylamide, N-isobutoxymethyl methacrylamide, itaconic acid, fumaric acid, vinyl acetate, vinyl propionate, vinyl butyrate, vinyl laurate, vinyl pivalate and vinyl 2-ethylhexanoate.

In one embodiment herein, Acrylate-based Polymer (b) is obtained by the copolymerization of monomers comprising acrylate or methacrylate and styrene.

The Tg of Acrylate-based Polymer (b) is suitably less than or equal to 10° C., preferably less than or equal to 0° C., and more preferably less than or equal to −12° C.

Due to costs, Component (b) should be present in an amount of suitably less than or equal to 25%, more preferably less than or equal to 20%, based on the total weight of the aqueous dispersion. Considering the elasticity of the aqueous dispersion, Component (b) should be present in an amount of preferably at least 8%, more preferably at least 11%, based on the total weight of the aqueous dispersion. In a preferred embodiment herein, Component (b) is present in an amount of from 8% to 25%, in particular from 11% to 20%, based on the total weight of the aqueous dispersion.

In the present disclosure, the polymer as Component (b) can be prepared by a conventional method in the art, typically by emulsion polymerization, and thus obtained in a form of polymer dispersion. The Polymer (b)-based dispersion has a pot life of preferably longer than or equal to 4 hours after being mixed with cement. In one embodiment herein, Polymer (b) is stably dispersed in water with a surfactant.

In one embodiment of the present disclosure, the weight ratio of Polymer (a) to Polymer (b) ranges from 55:45 to 75:25. In a more particular embodiment herein, the weight ratio of Polymer (a) to Polymer (b) ranges from 60:40 to 70:30.

### Component (c)

In the present disclosure, water is typically present in an amount of 10%-70%, for example, from 15% to 65%, from 20% to 60%, in particular, from 30% to 50%, based on the total weight of the aqueous dispersion.

### Other Components

The aqueous dispersion of the present disclosure may further comprise other components such as polyvinyl alcohols, surfactants, defoamers and preservatives, as long as the objective of the present invention would not be compromised.

Polyvinyl alcohol is used to stably disperse Polymer (a) in water. Suitable polyvinyl alcohols can be PVOH 25/88, PVOH 117 and/or PVOH 04/88, but are not limited thereto. In the present disclosure, there are no special requirements for the amount of polyvinyl alcohol, as long as it enables a stable effect of polymers.

Surfactants are used to stably disperse Polymer (b) in water, which suitably include anionic and nonionic surfactants. In one embodiment of the present disclosure, Polymer (b) is stably dispersed in water with anionic and nonionic surfactants. In the embodiment, there are no special requirements for the amount of surfactants, as long as it enables a stable effect of polymers.

Surfactants can also increase the elasticity of polymer modified cement-based coatings prepared from the aqueous dispersions. Of course, surfactants used to increase elasticity may not be included in the aqueous dispersion, but included in the liquid components of polymer modified cement-based coatings. In one embodiment of the present disclosure, the aqueous dispersion is additionally supplemented with an appropriate amount of a surfactant, preferably a nonionic surfactant, particularly a nonionic surfactant having an HLB value of from 10 to 20, to enhance the elastic property of the aqueous dispersion when used in polymer modified cement-based coatings.

Defoamers may be any reagent having a defoaming effect on the aqueous dispersion. Preservatives may be any reagent that is beneficial to the storage stability of the aqueous dispersion. Chemical compositions of these components are not critical to the present invention.

In particular, the aqueous dispersion of the present disclosure does not comprise a plasticizer, wherein “not comprise” means that the plasticizer is present in the aqueous dispersion in an amount of lower than 0.1 wt %, or even lower than 0.05 wt % or 0.01 wt %. Examples of the plasticizers include, but are not limited to: phthalate plasticizers (such as dibutyl phthalate, diisobutyl phthalate, dioctyl phthalate, diisodecyl phthalate, and diisononyl phthalate), aliphatic dibasic acid ester plasticizers (such as dioctyl adipate, diisodecyl adipate, dioctyl sebacate, and diisooctyl sebacate), fatty acid ester plasticizers (such as stearate), alkylsulfonate plasticizers, phosphate plasticizers, polyether polyol plasticizer, paraffin wax, and the like.

In the present disclosure, the film formed from the aqueous dispersion has a midpoint Tg value of less than or equal to −7° C., particularly less than or equal to −8° C. In order to further increase the elasticity of the aqueous dispersion when used in polymer modified cement-based coatings, the offset Tg value of the film formed therefrom is preferably less than −1° C.

In the present disclosure, the aqueous dispersion has a pH value of from 5 to 7, particularly from 6 to 7. A too high or too low pH value is not conducive to the storage stability of the aqueous dispersion.

In the present disclosure, the aqueous dispersion has a dynamic viscosity at 25° C. of suitably less than 3,000 mPa·s, particularly less than 2,000 mPa·s.

In the present disclosure, the aqueous dispersion has a solid content of suitably more than 30 wt %, such as more than 40 wt %, more than 50 wt %, or even more than 55 wt %. In order to facilitate storage stability of the aqueous dispersion, the solid content is suitably less than 90 wt %, such as less than 80 wt %, less than 70 wt %, or less than 65 wt %.

In the present disclosure, the aqueous dispersion can be used as a liquid ingredient in polymer modified cement-based coatings, including Type I and Type II, especially Type I.

The second aspect of the disclosure also provides a polymer modified cement-based coating composition comprising the foregoing aqueous dispersion, optionally further comprising water, cement, fillers and additives.

In the present disclosure, the cement is a conventional Portland cement commonly used in the art, for example, grades 32.5, 42.5, 42.5R, and 52.5.

The particle size of fillers ranges typically from 100 to 500 mesh. Suitable fillers can be exemplified by quartz powder, quartz sand, wollastonite powder and calcium carbonate, but are not limited thereto.

The additives can be exemplified by plasticizers, defoamers, antifreezes, cellulose ethers and superplasticizers. Here, examples of the plasticizers include, but are not limited to, the aforementioned examples. Examples of the deformers include, but are not limited to: mineral oil defoamers, high-carbon alcohol defoamers, polyether defoamers and silicone-based defoamers such as Defoamer 318, Defoamer 1340, and Defoamer 1370. Examples of the antifreezes include, but are not limited to: propylene glycol and glycerol. Examples of the superplasticizers include, but are not limited to: lignosulfonate superplasticizers, naphthalene superplasticizers, melamine superplasticizers, sulfamate superplasticizers, fatty acid-based superplasticizers, and polycarboxylate superplasticizers.

Preferably, the polymer modified cement-based coating composition does not comprise a plasticizer, wherein “not comprise” means that the plasticizer is present in the composition in an amount of lower than 0.1 wt %, or even lower than 0.05 wt % or 0.01 wt %.

### DETAILED DESCRIPTION OF THE PREFERRED EMBODIMENTS

The present invention is further illustrated by the following examples, but is not limited to the scope thereof. Any experimental methods with no conditions specified in the following examples are selected according to the conventional methods and conditions, or product specifications.

### Determination of Tg

An appropriate amount of the aqueous dispersion was taken to be dried at 130° C. for 30 min to form a film. The Tg of the film was tested on NETZSCH DSC 200 F3 in the temperature range of from −70° C. to 100° C. at a scan rate of 10° C./min. The Tg values here are midpoint values.

### Determination of Tensile Strength, Elongation at Break and Low-Temperature Flexibility

The polymer modified cement-based coating film was prepared and its low temperature flexibility at −10° C., tensile strength and elongation at break were tested according to the Chinese national standard GB/T 23445-2009.

The ingredients in Table 1-2 are all commercially available, with detailed information as follows:

Aqueous dispersion 1 of vinyl acetate-ethylene copolymer, plasticizer-free, stabilized by PVOH, Tg=−6.0° C., having a solid content of from 54.0% to 56.0%, an ethylene unit content of 24.0 wt % and a pot life of longer than 4 hours after being mixed with cement, supplied by Wacker Chemicals;

Aqueous dispersion 2 of vinyl acetate-ethylene copolymer, plasticizer-free, stabilized by PVOH, Tg=−5.2° C., having a solid content of from 54.0% to 56.0%, an ethylene unit content of 21.9 wt % and a pot life of longer than 4 hours after being mixed with cement, supplied by Wacker Chemicals;

Aqueous dispersion 3 of vinyl acetate-ethylene copolymer, plasticizer-free, stabilized by PVOH and a nonionic surfactant, Tg=10.3° C., having a solid content of from 54.0% to 56.0%, an ethylene unit content of 14.4 wt % and a pot life of longer than 4 hours after being mixed with cement, supplied by Wacker Chemicals;

Aqueous dispersion of vinyl acetate-ethylene-butyl acrylate copolymer, plasticizer-free, stabilized by a nonionic surfactant, Tg=−15.0° C., having a solid content of from 54.0% to 56.0%, an ethylene unit content of 19.1 wt % and a pot life of less than 4 hours after being mixed with cement, supplied by Wacker Chemicals;

Mowilith DM 686, an aqueous dispersion of styrene-acrylate copolymer, plasticizer-free, stabilized by a surfactant, Tg=−13.0° C., having a solid content of from 54.5% to 57.5% and a pot life of longer than 4 hours after being mixed with cement, supplied by Archroma;

Mowilith DM 637, an aqueous dispersion of styrene-methacrylate copolymer, plasticizer-free, stabilized by a surfactant, Tg=−6.0° C., having a solid content of from 49.0% to 51.0% and a pot life of longer than 4 hours after being mixed with cement, supplied by Archroma;

Rhodoline 2809, a nonionic surfactant, AEPO-free, having a an active substance content of 90 wt % and an HLB value of 13.0, supplied by Solvay Fine Chemicals;

SN-DEFOAMER 318, a defoamer, supplied by Sannopco;

MELMENT F10, a superplasticizer, supplied by BASF.

The amounts in Table 1-2 are in parts by weight unless otherwise specified.

### EXAMPLES 1-2 AND COMPARATIVE EXAMPLES 1-4

### Aqueous Dispersions

According to the formulation in Table 1, the components were uniformly mixed to obtain an aqueous dispersion with a pH value of from 6 to 7.

The Tg values of the films formed from the resulting aqueous dispersions and the pot lives of the dispersions after being mixed with cement were tested.

TABLE 1

| Components | Ex. 1 | Ex. 2 | C. Ex. 1 | C. Ex. 2 | C. Ex. 3 | C. Ex. 4 | C. Ex. 5 |
|---|---|---|---|---|---|---|---|
| Aqueous dispersion | 70 | 60 | — | — | — | — | 70 |
| 1 of vinyl | | | | | | | |
| acetate/ethylene | | | | | | | |
| copolymer | | | | | | | |
| Aqueous dispersion | — | — | 70 | — | — | — | — |
| 2 of vinyl | | | | | | | |
| acetate/ethylene | | | | | | | |
| copolymer | | | | | | | |
| Aqueous dispersion | — | — | — | 70 | — | — | — |
| 3 of vinyl | | | | | | | |
| acetate/ethylene | | | | | | | |
| copolymer | | | | | | | |
| Aqueous dispersion | — | — | — | — | 70 | — | — |
| of vinyl acetate- | | | | | | | |
| ethylene-butyl | | | | | | | |
| acrylate copolymer | | | | | | | |
| Mowilith DM 686 | 30 | 40 | 30 | 30 | 30 | 20 | — |
| Mowilith DM 637 | — | — | — | — | — | — | 30 |
| Rhodoline 2809 | 0.2 | 0.2 | 0.2 | 0.2 | 0.2 | 0.2 | 0.2 |
| SN-DEFOAMER 318 | 0.2 | 0.2 | 0.2 | 0.2 | 0.2 | 0.2 | 0.2 |

Index

| | | | | | | | |
|---|---|---|---|---|---|---|---|
| Midpoint Tg value | −9.3 | −8.0 | −2.9 | −13.3 | −11.9 | −6.5 | >−7 |
| of the film | | | | 9.0 | | | |
| formed from the | | | | | | | |
| resulting aqueous | | | | | | | |
| dispersion*/° C. | | | | | | | |
| Offset Tg value | −1.3 | −2.7 | 0.9 | −7.1 | −3.8 | −1.0 | >−1 |
| of the film | | | | 22.9 | | | |
| formed from the | | | | | | | |
| resulting aqueous | | | | | | | |
| dispersion*/° C. | | | | | | | |
| Pot life of the | >4 h | >4 h | >4 h | >4 h | <4 h | >4 h | >4 h |
| resulting aqueous | | | | | | | |
| dispersi-on after | | | | | | | |
| being mixed with | | | | | | | |
| cement/h | | | | | | | |

*For Examples 1-2 and Comparative Examples 1, 3-5, only a single transition temperature was found on the heat flow-temperature curve, indicating that the blend is miscible;
In Comparative Example 2, two independent transition temperatures were found on the heat flow-temperature curve, indicating that the blend is immiscible.

### EXAMPLE 3

### Polymer Modified Cement-Based Coating Compositions

According to the formulation in Table 2, the aqueous dispersions of Examples 1-2 and Comparative Examples 1-4 were respectively used as the main liquid ingredients, then the liquid ingredients and powder ingredients were respectively mixed well to obtain the liquid and powder components, which were mixed, according to the ratio specified in Table 2, to obtain Type I and Type II polymer modified cement-based coatings.

TABLE 2

| Components | Ingredients | JS I | JS II |
|---|---|---|---|
| Liquids | Aqueous dispersion | 90 | 85 |
| | SN-DEFOAMER 318 | 0.5 | 0.8 |
| | Water | 9.5 | 14.2 |
| | Total | 100 | 100 |
| Powders | White cement | 40 | 40 |
| | (Grade 32.5) | | |
| | Ground calcium carbonate | 30 | 30 |
| | (400 mesh) | | |
| | Wollastonite powder | 29.5 | 29.5 |
| | MELMENT F10 | 0.5 | 0.5 |
| | Total | 100 | 100 |

| | | |
|---|---|---|
| Mass ratio of liquid component to powder component | 1:0.8 | 1:1.2 |

Table 3 shows the test results of low temperature flexibility at −10° C., tensile strength and elongation at break of the polymer modified cement-based coatings prepared from the aqueous dispersions of Examples 1-2 and Comparative Examples 1-4.

TABLE 3

| | JS I | | | JS II | |
|---|---|---|---|---|---|
| | Low-temperature | Tensile | Elongation at | Tensile | Elongation at |
| | flexibility at −10° C. | strength/Mpa | break/% | strength/MPa | break/% |
| Ex. 1 | Passed | 2.14 | 304.13 | 3.62 | 99.69 |
| Ex. 2 | Passed | 1.66 | 244.72 | NA | NA |
| C. Ex. 1 | Failed | NA | NA | NA | NA |
| C. Ex. 2 | Failed | NA | NA | NA | NA |
| C. Ex. 3 | Failed | NA | NA | NA | NA |
| C. Ex. 4 | Failed | NA | NA | NA | NA |
| C. Ex. 5 | Failed | 4.13 | 117.57 | 4.03 | 38.59 |

1-15. (canceled)

16. An aqueous dispersion, comprising:
an aqueous dispersion comprising Component (a), Component (b) and Component (c);
wherein Component (a) is a polymer prepared by the polymerization of monomers comprising a vinyl ester and an ethylene;
wherein Component (b) is an acrylate-based polymer;
wherein Component (c) is water;
wherein a film that is formed from the aqueous dispersion has a glass transition temperature of less than or equal to −7° C.;
wherein the aqueous dispersion has a pot life of longer than or equal to 4 hours after being mixed with cement;
wherein the pot life of the aqueous dispersion of the polymer of the Component (a) after being mixed with cement is longer than or equal to 4 hours;
wherein Component (a) is present in an amount of higher than 35%, based on the total weight of the aqueous dispersion; and
wherein Component (b) is present in an amount of less than or equal to 20%, based on the total weight of the aqueous dispersion.

17. The aqueous dispersion of claim 16, wherein the polymer of the Component (a) has a glass transition temperature of less than or equal to 5° C.

18. The aqueous dispersion of claim 16, wherein the content of ethylene units derived from ethylene in the polymer of the Component (a) is more than 22 wt % based on the total weight of the polymer.

19. The aqueous dispersion of claim 16, wherein the polymer of the Component (a) is a stably dispersed in water with polyvinyl alcohol.

20. The aqueous dispersion of claim 16, wherein the Component (a) is a vinyl acetate-ethylene copolymer.

21. The aqueous dispersion of claim 16, wherein the polymer of the Component (b) has a glass transition temperature of less than or equal to −12° C.

22. The aqueous dispersion of claim 16, wherein the pot life of the aqueous dispersion of the polymer of the Component (b) after being mixed with cement is longer than or equal to 4 hours.

23. The aqueous dispersion of claim 16, wherein the Component (b) is present in an amount of from 8% to 20%, based on the total weight of the aqueous dispersion.

24. The aqueous dispersion of claim 16, wherein the polymer of the Component (a) and the polymer of the Component (b) have been prepared by emulsion polymerization.

25. The aqueous dispersion of claim 16, wherein a pH value of the aqueous dispersion is from 5 to 7.

26. The aqueous dispersion of claim 16, wherein a dynamic viscosity of the aqueous dispersion is less than 3,000 mPa·s at 25° C.

27. The aqueous dispersion of claim 16, characterized by a solid content of more than 50 wt %.

28. The aqueous dispersion of claim 16, wherein a plasticizer is present in an amount of lower than 0.1 wt %, based on the total weight of the aqueous dispersion.

29. The aqueous dispersion of claim 16, wherein the aqueous dispersion is a polymer modified cement-based coating composition.

30. The composition of claim 29, wherein a plasticizer is present in an amount of less than 0.1 wt %, based on the total weight of the composition.
